(19) United States
(12) Patent Application Publication
(10) Pub. No.: US 2012/0009350 A1
(43) Pub. Date: Jan. 12, 2012

(54) Electroless autocatalytic tin plating solution and electroless autocatalytic tin plating method using the same

(75) Inventors: Jin Hyuck Yang, Yongin (KR); Yong Seok Kim, Seongnam (KR); Chang Hwan Choi, Seongnam (KR)

(73) Assignee: SAMSUNG ELECTRO-MECHANICS CO., LTD., Suwon (KR)

(21) Appl. No.: 12/929,042

(22) Filed: Dec. 23, 2010

(30) Foreign Application Priority Data
Jul. 7, 2010 (KR) 10-2010-0065448

(51) Int. Cl. B05D 1/18; C09D 5/00

(52) U.S. Cl. 427/443.1; 106/1.25

(57) ABSTRACT

Disclosed are an electroless autocatalytic tin plating solution and an electroless autocatalytic tin plating method using the same. The electroless autocatalytic tin plating solution includes: tin salt formed as a tin ion and a ligand having two or more carboxyl groups are bound; and one or more reductants selected from the group consisting of borohydrides delivering electrons to the tin ion to form a tin layer on a target object to be plated.

### CROSS-REFERENCE TO RELATED APPLICATIONS

This application claims the priority of Korean Patent Application No. 10-2010-0065448 filed on Jul. 7, 2010, in the Korean Intellectual Property Office, the disclosure of which is incorporated herein by reference.

### BACKGROUND OF THE INVENTION

1. Field of the Invention

The present invention relates to an electroless autocatalytic tin plating solution and an electroless autocatalytic tin plating method using the same and, more particularly, to an electroless tin reduction plating solution capable of forming a dense, uniform tin coating film, and an electroless tin reduction plating method using the same.

2. Description of the Related Art

Solder balls in use to mount an IC chip, and the like, on PCB(printed circuit board) have been replaced by precise plating due to the trend for high-density wirings and thinner substrates and in order to reduce manufacturing costs.

A tin layer is formed on a copper pad of the PCB through electroplating, and the use of the electroplating technique may possibly cause the tin layer to have a non-uniform thickness because of non-uniform current density. Consequently, connections between the copper pad of the PCB and IC chips are not facilitated and so the reliability of an overall product may be degraded. Also, to perform electroplating, equipment for applying voltages must be added to an electroplating bath, resultantly increasing the size of equipment, complicating the process because of the use of high-priced equipment, and increasing manufacturing costs.

Thus, a method for forming a tin layer through electroless plating, rather than through electroplating, has been attempted. Electroless plating exhibits a high plating performance ensuring a dense, uniform tin layer, improving the quality of an overall product.

The electroless plating method includes an electroless immersion plating method based on the principle that metal atoms of a substrate desired to be plated are eluted as metal ions into a plating solution and other metal ions within the plating solution, which have received electrons from the metal atoms, are electrodeposited (or plated) onto a surface of the substrate.

However, the use of the electroless immersion plating method advantageously allows for a formation of a tin layer having a certain thickness or larger but potentially causes the formation of an air void between the copper pad and the tin layer. In addition, the elution of the copper cation of the copper pad into the plating solution leads to an corrosion of the copper pad, intermetallic diffusion, an undercut, and the like, making it difficult to fabricate a reliable wiring substrate.

In an effort to solve the problem, there has been an attempt to plate tin according to an electroless reduction plating method, rather than the electroless immersion plating method; however, tin has low autocatalytic activity, so a reductant (or a reducing agent) that allows for the possibility of plating tin as high as a desired level has yet to be developed. Thus, the development of a proper reductant emerges as a significant issue.

### SUMMARY OF THE INVENTION

An aspect of the present invention provides an electroless autocatalytic tin plating solution capable of forming a dense, uniform tin layer, and an electroless autocatalytic tin plating method using the same.

According to an aspect of the present invention, there is provided an electroless autocatalytic tin plating solution including: tin salt formed as a tin ion and a ligand having two or more carboxyl groups are bound; and one or more reductants selected from the group consisting of borohydrides delivering electrons to the tin ion to form a tin layer on a target object to be plated.

The tin salt may be tin oxalate including oxalate represented by chemical formula shown below:

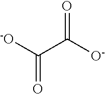

The content of the tin salt may range from 5 g/L to 20 g/L.

The borohydride may be sodium borohydride, potassium borohydride, or lithium borohydride.

The content of the reductant may range from 1 g/L to 10 g/L.

The potential of hydrogen (pH) of the electroless autocatalytic tin plating solution may range from 10 to 11.

The electroless autocatalytic tin plating solution may include one or more additives selected from the group consisting of a complexing agent, an accelerator, and an antioxidant.

The electroless autocatalytic tin plating solution may include one or more first complexing agents selected from the group consisting of an amino compound and a carbonyl compound having shared electron pairs available for coordinate bonding with a metal ion, and one or more second complexing agents selected from the group consisting of an amino compound and a carbonyl compound having lower bonding energy with a tin ion than that of the first complexing agent.

The content of the first complexing agent may range from 50 g/L to 150 g/L, and the content of the second complexing agent may range from 1 g/L to 20 g/L.

According to another aspect of the present invention, there is provided an electroless tin reduction plating method including: preparing an electroless autocatalytic tin plating solution including tin salt formed as a tin ion and a ligand having two or more carboxyl groups are bound, and one or more reductants selected from the group consisting of borohydrides delivering electrons to the tin ion to form a tin layer on a target object to be plated; and immersing the target object in the electroless autocatalytic tin plating solution.

The tin salt may be tin oxalate including oxalate represented by chemical formula shown below:

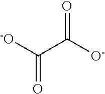

The potential of hydrogen (pH) of the electroless autocatalytic tin plating solution may range from 10 to 11.

The immersing of the target object may be performed at 25 Celsius degrees to 80 Celsius degrees for 30 minutes to 60 minutes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a graph showing the thicknesses of tin layer formed through the electroless autocatalytic tin plating solutions of the Embodiment Example and the Comparative Example.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

An electroless autocatalytic tin plating solution according to an exemplary embodiment of the present invention may include: tin salt formed as a tin ion and a ligand having two or more carboxyl groups are bound; and one or more reductants (or reducing agents) selected from the group consisting of borohydrides delivering electrons to the tin ion to form a tin coated film on a target object to be plated.

The electroless autocatalytic tin plating solution according to an exemplary embodiment of the present invention includes a reductant, and receives electrons required for the precipitation of tin according to the oxidization of the reductant. Namely, electrons generated from the reductant are delivered to a tin ion, and the reduced tin ion is electrodeposited on a target object to be plated to form a tin layer thereon. Thus, unlike the related art electroless substitution reaction, because tin ions do not use electrons generated as a metal constituting a target object to be plated is dissolved, the tin layer can be formed on the target object to be plated without causing a loss such as erosion, or the like, from the target object. Thus, an electronic component-mounted substrate can be fabricated without a loss of metal wirings which are becoming thinner, or the like.

As tin salt included in the electroless autocatalytic tin plating solution according to an exemplary embodiment of the present invention, tin salt which is formed as tin ion and a ligand (a complexing agent) having two or more carboxyl groups are bound may be used. The ligand having carboxyl groups may be coordinate bonded with tin ion to generate a chelate compound so as to act as a complexing agent.

The ligand having two or more carboxyl groups is not limited. For example, an oxalate represented by the chemical equation below may be used. Thus, the electroless autocatalytic tin plating solution according to an exemplary embodiment of the present invention may use tin oxalate.

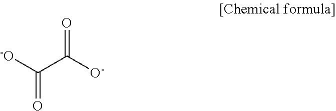

Oxalate, including two carboxyl groups which are positioned to be adjacent, has high bonding energy with tin ions.

It is difficult to increase a plating speed with a generally used tin salt, such as a tin salt bonded with a halogen element (Cl, F, etc.), stannous sulfate, and the like, because the halogen ion or the sulfuric ion erodes the target object to be plated.

In comparison, however, tin oxalate does not cause erosion of the target object to be plated and serves to restrain a reaction of a material adsorbed onto the surface of the target object to be plated to cause erosion of the target object to be plated. Thus, in an exemplary embodiment of the present invention, the target object to be plated can be prevented from being eroded by using tin oxalate and a plating speed can be improved.

In addition, when a tin ion is reacted to the reductant in the solution, not on the surface of the target object to be plated, sludge is generated. However, when a compound such as an oxalate having high bonding energy with the tin ion acts as a complexing agent, the probability of sludge generation can be reduced, thus securing the stability of the plating solution and facilitating the regulation of temperature for increasing the plating speed.

In addition, because the tin salt is used, a smaller amount of borohydride, the reductant, can be contained.

The content of the tin salt may range from 5 g/L to 20 g/L, but it is not limited thereto. If the content of the tin salt is lower than 5 g/L, the plating speed would possibly be degraded, and if the content of the tin salt exceeds 20 g/L, the solution would become unstable to generate sludge or cause the formation of a tin coated film beyond the target plating area.

The electroless autocatalytic tin plating solution according to an exemplary embodiment of the present invention may include one or more reductants selected from the group constituting of borohydrides.

As the reductant included in the electroless autocatalytic tin plating solution, a reductant that can be oxidized to generate electrons and reduce tin ion by using the generated electrons may be used.

Tin has a high hydrogen overvoltage and low autocatalytic activity, and performing autocatalytic precipitation on the surface of the target object to be plated stably is very difficult with tin. However, when the borohydride is used as the reductant, electrons can be transferred to the tin ion and the tin ion can be reduced to be stably precipitated on the target object to be plated.

The borohydride is a strong reductant, enabling the autocatalytic activity of tin.

The borohydride is not particularly limited. For example, the borohydride may include sodium borohydride, potassium borohydride, lithium borohydride, and the like, and one or more of these may be combined to be used.

The content of the reductant may range from 1 g/L to 10 g/L, but it is not limited thereto.

If the content of the reductant is less than 1 g/L, it would be difficult to precipitate tin ion or a long period of time would possibly be required to precipitate tin ion, and if the content of the reductant exceeds 10 g/L, there is a possibility that the plating solution will become unstable.

Preferably, the potential of hydrogen (pH) of the electroless autocatalytic tin plating solution according to an exemplary embodiment of the present invention may range from 10 to 11. If the electroless autocatalytic tin plating solution has acidic conditions, electrons generated according to oxidation of the borohydride would react with hydrogen ions in the solution to generate a hydrogen gas and degrade the electroplating reaction of tin ion. Thus, in order to stably transfer electrons from the borohydride, the electroless autocatalytic tin plating solution may have the pH ranging from 10 to 11.

The electroless autocatalytic tin plating solution according to an exemplary embodiment of the present invention may additionally include other additives such as a complexing agent, an accelerator, an antioxidant, and the like.

The complexing agent serves to prevent the metal ion from being oxidized, to be precipitated in the plating solution in the course of plating operation and to restrain a sludge generation reaction caused as the metal ion is reacted to the reductant in the solution.

The electroless autocatalytic tin plating solution according to an exemplary embodiment of the present invention may include an amino compound or a carbonyl compound having shared electron pairs available for coordinate bonding with a metal ion, as a first complexing agent. The first complexing agent has such high bonding energy with the tin ion so as to provide solution stability. As the first complexing agent, ethylene diamine tetraacetic acid (EDTA), [bis(phosphonomethyl)amino] methyl phosphonic acid, trans-1,2-diaminocyclohexane-N,N,N′,N′-tetraacetic acid, (S,S)-ethylenediamine-N,N′-disuccinic acid, or Sodium citrate may be used, but the present invention is not limited thereto.

The content of the first complexing agent may range from 50 g/L to 150 g/L, but it is not limited thereto. If the content of the first complexing agent is lower than 50 g/L, the first complexing agent would be likely to react to the reductant in the solution to generate sludge, and if the content of the first complexing agent exceeds 150 g/L, the plating speed would be likely to degrade.

In addition, the electroless autocatalytic tin plating solution according to an exemplary embodiment of the present invention may include one or more selected from the group consisting of an amino compound and a carbonyl compound having lower bonding energy with the tin ion than that of the first complexing agent, as second complexing agents.

As the second complexing agent, oxalate having a structure in which two carboxyl groups are adjacent, or the like, may be used, but the present invention is not limited thereto. Oxalate may be coordinate bonded with the tin ion to generate a chelate compound, thus reducing the possibility that the tin ion will react to the reductant in the solution, rather than on the target object to be plated.

Thus, the sludge generation possibility in the plating solution can be lowered, and temperature for increasing the plating speed can be easily regulated.

The content of the second complexing agent may range from 1 g/L to 20 g/L, but it is not limited thereto. Without the second complexing agent, the plating speed can be increased because the tin salt includes a ligand having the carboxyl group, but the presence of the second complexing agent can adjust the plating speed according to the temperature desired to be employed.

If the content of the second complexing agent exceeds 20 g/L, the plating solution would be likely to become unstable.

An accelerator serves to prevent spontaneous decomposition of the reductant. The inclusion of the accelerator can lead to an increase in the plating speed.

The reductant must have stability in the plating solution and should not be easily decomposed in the plating solution nor react to other additives. By including the accelerator, the stability of the reductant can be secured and an electron transmission capability of the tin ion can be improved.

The accelerator is not particularly limited. Namely, any accelerator used in the art may be used so long as it can prevent spontaneous decomposition of the borohydride. For example, sodium acetate may be used as the accelerator, but the present invention is not limited thereto.

The content of the accelerator may range from 1 mg/L to 20 g/L, but it is not limited thereto. If the content of the accelerator is lower than 1 mg/L, the reductant would be spontaneously decomposed to degrade the plating speed, while if the content of the accelerator exceeds 20 g/L, the solution would be likely to become unstable.

An antioxidant may be added to prevent a divalent tin ion from being oxidized into a tetravalent tin ion, thus increasing the plating speed. The antioxidant is not particularly limited, and any antioxidant used in the art may be used. For example, a phosphorus compound, a hydrazine derivative, or the like, may be used as the antioxidant. Also, for example, sodium hypophosphate may be used as the antioxidant.

The content of the antioxidant may range from 1 mg/L to 20 g/L, but it is not limited thereto. If the content of the antioxidant is less than 1 mg/L, the plating speed would be likely to be degraded, and if the content of the antioxidant exceeds 20 g/L, the antioxidant would be likely to be positioned on the surface of the target object to be plated to hinder the oxidation between the borohydride used as the reductant and the target object to be plated.

Another exemplary embodiment of the present invention provides an electroless autocatalytic tin plating method using an electroless autocatalytic tin plating solution.

The electroless autocatalytic tin plating method according to an exemplary embodiment of the present invention uses the foregoing electroless autocatalytic tin plating solution. Detailed components and actions of the electroless autocatalytic tin plating solution are as described above.

An electroless autocatalytic tin plating solution according to an exemplary embodiment of the present invention may be prepared, and a target object to be plated may be dipped in the electroless autocatalytic tin plating solution.

The dipping of the target object in the electroless autocatalytic tin plating solution may be performed at 25 Celsius degrees to 80 Celsius degrees for 30 minutes to 60 minutes.

The target object to be plated may be copper or other metal products, but it is not limited thereto. Also, a mounting substrate with a metal such as copper or the like formed as a wiring may be used as the target object to be plated.

As described above, the electroless autocatalytic tin plating solution according to an exemplary embodiment of the present invention has excellent stability and plating speed and has such characteristics that the temperature for adjusting the plating speed can be regulated.

Also, according to an exemplary embodiment of the present invention, electrons required for precipitate tin are provided through oxidization of the reductant, and in this case, because the metal constituting the target object is not dissolved, a loss such as erosion of the target object can be prevented and a dense, uniform tin layer may be formed.

Accordingly, a mounting substrate can be fabricated without causing a loss of a metal pattern as a thin film, or the like.

The present invention will now be described in more detail with reference to an Embodiment Example and Comparative Example.

Electroless autocatalytic tin plating solutions including the compositions as shown in Table 1 below were prepared and electroless autocatalytic tin plating was performed on a copper layer.

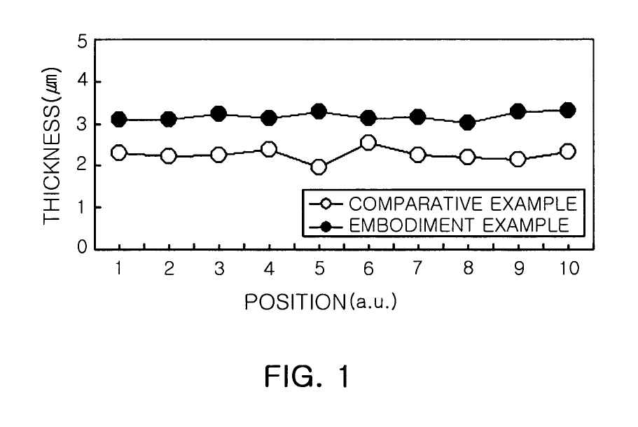

The thickness of a tin layer formed by the electroless autocatalytic tin plating solutions according to Embodiment Example and Comparative Example were measured by XRF (SII Nano Technology Inc. SFT9200) and the results are shown in FIG. 1.

TABLE 1

| | | Comparative |
|---|---|---|
| | Embodiment Example | Example |
| Tin salt (content) | Tin oxalate 10 g/L | Stannous chloride 12 g/L |
| First complexing | EDTA 70 g/L | EDTA 70 g/L |
| agent (content) | | |
| Second complexing | Oxalate 5 g/L | Citrate 18 g/L |
| agent (content) | | |
| Reductant | NaBH₄ 3 g/L | NaBH₄ 3 g/L |
| (content) | | |
| pH | 10.3 | 10.3 |
| Temperature | 45 Celsius degrees | 40 Celsius degrees |
| Plating speed | 3 μm/hr | 2 μm/hr |

With reference to FIG. 1, it is noted that the thickness of the tin layer according to the Embodiment Example of the present invention is larger and the plating speed is faster than those of Comparative Example. Also, it was confirmed from the results obtained by analyzing copper concentration in the plating solution according to Embodiment Example after performing plating that the concentration of copper was 1 mg/L, which was few or no.

As set forth above, according to exemplary embodiments of the invention, the electroless autocatalytic tin plating solution includes a reductant, and electrons required for precipitating tin are provided according to oxidization of the reductant. Thus, unlike the related art electroless substitution reaction, a tin layer can be formed on a target object without causing a loss such as erosion of the target object, or the like.

In addition, because the electroless autocatalytic tin plating solution includes tin salt formed as tin ion and a ligand having two or more carboxyl groups are bound, the likelihood of generation of sludge can be lowered, and because the electroless autocatalytic tin plating solution includes a small amount of borohydride, a reductant, stability of the plating solution can be secured. In addition, because regulation of temperature for increasing a plating speed is facilitated, a dense, uniform tin layer can be formed.

While the present invention has been shown and described in connection with the exemplary embodiments, it will be apparent to those skilled in the art that modifications and variations can be made without departing from the spirit and scope of the invention as defined by the appended claims.

What is claimed is:

1. An electroless autocatalytic tin plating solution comprising:
tin salt formed as a tin ion and a ligand having two or more carboxyl groups are bound;
one or more reductants selected from the group consisting of borohydrides delivering electrons to the tin ion to form a tin layer on a target object to be plated.

2. The electroless autocatalytic tin plating solution of claim 1, wherein the tin salt is tin oxalate including oxalate represented by chemical formula shown below:

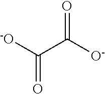

3. The electroless autocatalytic tin plating solution of claim 1, wherein the content of the tin salt may range from 5 g/L to 20 g/L.

4. The electroless autocatalytic tin plating solution of claim 1, wherein the borohydride is sodium borohydride, potassium borohydride, or lithium borohydride.

5. The electroless autocatalytic tin plating solution of claim 1, wherein the content of the reductant ranges from 1 g/L to 10 g/L.

6. The electroless autocatalytic tin plating solution of claim 1, wherein the potential of hydrogen (pH) of the electroless autocatalytic tin plating solution ranges from 10 to 11.

7. The electroless autocatalytic tin plating solution of claim 1, wherein the electroless autocatalytic tin plating comprises one or more additives selected from the group consisting of a complexing agent, an accelerator, and an antioxidant.

8. The electroless autocatalytic tin plating solution of claim 1, wherein the electroless autocatalytic tin plating solution comprises one or more first complexing agents selected from the group consisting of an amino compound and a carbonyl compound having shared electron pairs available for coordinate bonding with a metal ion, and one or more second complexing agents selected from the group consisting of an amino compound and a carbonyl compound having lower bonding energy with a tin ion than that of the first complexing agent.

9. The electroless autocatalytic tin plating solution of claim 8, wherein the content of the first complexing agent ranges from 50 g/L to 150 g/L, and the content of the second complexing agent ranges from 1 g/L to 20 g/L.

10. An electroless autocatalytic tin plating method comprising:
preparing an electroless autocatalytic tin plating solution including tin salt formed as a tin ion and a ligand having two or more carboxyl groups are bound; and one or more reductants selected from the group consisting of borohydrides delivering electrons to the tin ion to form a tin layer on a target object to be plated; and
immersing the target object in the electroless autocatalytic tin plating solution.

11. The method of claim 10, wherein the tin salt is tin oxalate including oxalate represented by chemical formula shown below:

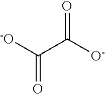

12. The method of claim 10, wherein the potential of hydrogen (pH) of the electroless autocatalytic tin plating solution ranges from 10 to 11.

13. The method of claim 10, wherein the immersing of the target object is performed at 25 Celsius degrees to 80 Celsius degrees for 30 minutes to 60 minutes.
